(19) United States
(12) Patent Application Publication
(10) Pub. No.: US 2019/0032657 A1
(43) Pub. Date: Jan. 31, 2019

(54) ELECTRIC OIL PUMP

(71) Applicant: NIDEC TOSOK CORPORATION, Kanagawa (JP)

(72) Inventors: Shigehiro KATAOKA, Kanagawa (JP); Yoshiyuki KOBAYASHI, Kanagawa (JP)

(73) Assignee: NIDEC TOSOK CORPORATION, Kanagawa (JP)

(21) Appl. No.: 16/048,380

(22) Filed: Jul. 30, 2018

(30) Foreign Application Priority Data
Jul. 31, 2017 (JP) 2017-148710
Jul. 6, 2018 (JP) 2018-128921

(51) Int. Cl. F04C 15/00; F04C 2/10; H02K 5/167; H02K 5/22; H02K 7/14; H02K 21/14

(52) U.S. Cl. CPC F04C 15/008; F04C 2/102; F04C 15/0038; H02K 5/1675; H02K 5/225; F04C 2240/50; H02K 21/14; F04C 2240/20; F04C 2240/40; F04C 2240/30; H02K 7/14

(57) ABSTRACT

An electric oil pump includes a motor unit having a shaft, and a pump unit which is disposed on a front side of a motor unit and is driven via the shaft and discharges oil. The motor unit includes a rotor that rotates around the shaft, a stator that is disposed to face the rotor, and a resin housing in which the rotor and the stator are housed. The pump unit includes a pump rotor installed to the shaft and a pump housing having a housing part in which the pump rotor is housed. A step that is recessed inwardly in the radial direction of the pump housing is provided on an outer surface outside the pump housing in the radial direction, the step is disposed on a rear side with respect to the housing part, and a front side end of the resin housing is fixed to the step.

### CROSS-REFERENCE TO RELATED APPLICATION

This application claims the priority of Japan patent applications serial no. 2017-148710, filed on Jul. 31, 2017 and no. 2018-128921, filed on Jul. 6, 2018. The entirety of the above-mentioned patent applications are hereby incorporated by reference herein and made a part of this specification.

### BACKGROUND

### Technical Field

The present disclosure relates to an electric oil pump.

### Description of Related Art

In recent years, when electric oil pumps used for transmissions mounted in vehicles have been installed in existing spaces in vehicles, there have been severe limitations in mounting, and reducing the size thereof is required so that they can be installed in various mounting spaces.

Regarding such electric oil pumps, an electric oil pump which includes a motor unit having a shaft and a pump unit that is disposed on one side of the motor unit in an axial direction and in which the pump unit is driven via the shaft of the motor unit and discharges oil is known. In this conventional electric oil pump, the shaft of the motor unit and the pump unit are supported by a pump body or a motor housing via a ball bearing and a sliding bearing, and thereby a reduction in size is realized.

For example, Japanese Laid-open Publication No. 2013-217223 discloses an electric oil pump in which a shaft that protrudes from one side of a motor unit in an axial direction is supported by a pump body via a ball bearing and a sliding bearing provided in a pump body of a pump unit. In addition, Japanese Laid-open Publication No. 2017-053323 discloses an electric oil pump in which a shaft that protrudes from one side of a motor unit in an axial direction is supported by a motor housing via a ball bearing fixed to the motor housing, and a shaft that protrudes from the other side of a rotor in the axial direction is supported by a motor housing via a sliding bearing.

In the electric oil pumps described in Japanese Unexamined Patent Application Publication No. 2013-217223 and Japanese Unexamined Patent Application Publication No. 2017-053323, in order to increase an amount of oil discharged without increasing the size of the electric oil pump, if the size of the motor unit increases, the diameter of the shaft increases, and it is necessary to increase the size of the bearing that supports the shaft. Therefore, as the size of the bearing increases, there is a possibility of the size of the electric oil pump increasing.

In addition, in order to increase an amount of oil discharged by the pump unit, a method of increasing the diameter of a pump rotor may be used. However, in the electric oil pumps described in Patent Document 1 and Patent Document 2, since the housing of the motor unit and the side wall of the pump cover are disposed outside the housing part in which the pump rotor is housed in the radial direction, an area outside the housing part in the radial direction is relatively narrow. Therefore, there is a limit to increasing the diameter of the pump rotor.

### SUMMARY

An exemplary first embodiment of the present disclosure is an electric oil pump including a motor unit having a shaft centered on a central axis that extends in an axial direction of the shaft; and a pump unit which is disposed on one side of the motor unit in the axial direction, is driven by the motor unit via the shaft, and discharges oil, wherein the motor unit includes a rotor that rotates around the shaft; a stator that is disposed to face the rotor; and a resin housing in which the rotor and the stator are housed, wherein the pump unit includes a pump rotor installed to the shaft that protrudes from the motor unit to the one side in the axial direction; and a pump housing having a housing part in which the pump rotor is housed, wherein a step that is recessed inwardly a the radial direction of the pump housing is provided on an outer surface outside the pump housing in the radial direction, wherein the step is disposed on an other side in the axial direction with respect to the housing part, and wherein one side end of the resin housing in the axial direction is fixed to the step.

The above and other elements, features, steps, characteristics and advantages of the present disclosure will become more apparent from the following detailed description of the exemplary embodiments with reference to the attached drawings.

### BRIEF DESCRIPTION OF THE DRAWINGS

FIG. 1 is a cross-sectional view of an electric oil pump according to a first embodiment.

FIG. 2 is a cross-sectional view of an electric oil pump according to a modified example of the first embodiment.

FIG. 3 is an enlarged cross-sectional view of a motor side flange part of a resin housing according to the first embodiment.

FIG. 4 is a cross-sectional view of an electric oil pump according to a modified example of the first embodiment.

FIG. 5 is a cross-sectional view of the electric oil pump according to the modified example of the first embodiment.

FIG. 6 is a cross-sectional view of the electric oil pump according to the modified example of the first embodiment.

### DESCRIPTION OF THE EMBODIMENTS

The present disclosure provides an electric oil pump that can increase an amount of oil discharged without increasing the size of the electric oil pump.

According to the exemplary first embodiment of the present disclosure, it is possible to provide an electric oil pump that can increase an amount of oil discharged without increasing the size of the electric oil pump.

An electric oil pump according to an embodiment of the present disclosure will be described below with reference to the drawings. In addition, in the following drawings, in order to allow respective configurations to be easily understood, actual structures and scales and numbers in the structures may vary.

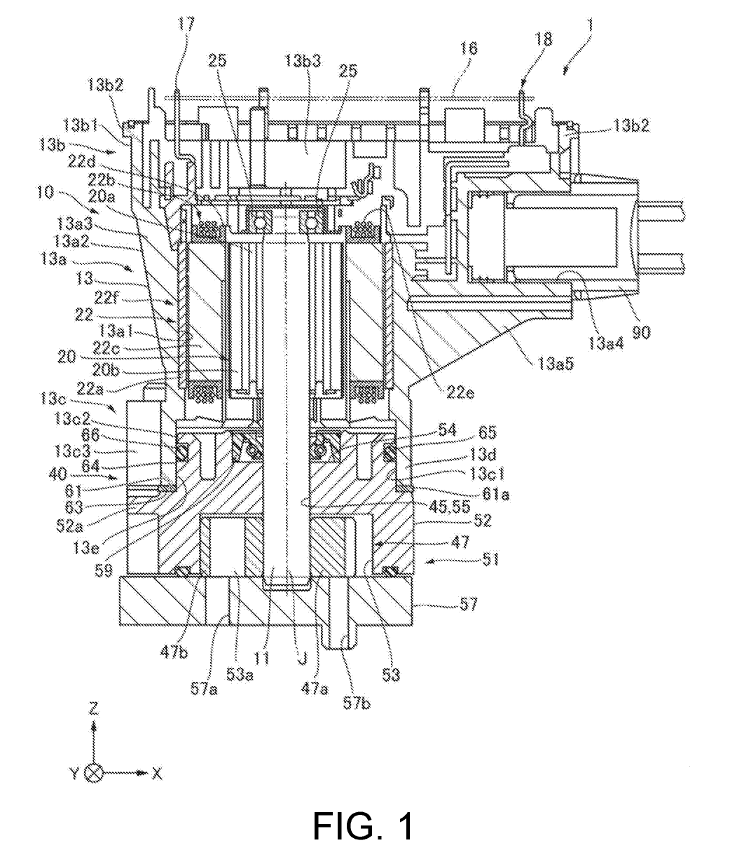

In addition, in the drawings, an XYZ coordinate system is appropriately shown as a three-dimensional orthogonal coordinate system. In the XYZ coordinate system, a Z axial direction is a direction parallel to the other side of a central axis J shown in FIG. 1 in the axial direction. An X axial direction is a direction parallel to an electric oil pump shown in FIG. 1 in a transverse direction, that is, a left-right direction in FIG. 1. A Y axial direction is a direction orthogonal to both the X axial direction and the Z axial direction.

In addition, in the following description, the positive side (+Z side) in the Z axial direction will be referred to as “rear side” and the negative side (−Z side) in the Z axial direction will be referred to as “front side.” Here, the rear side and the front side are terms that are simply used for explanation, and do not limit actual positional relationships and directions. In addition, unless otherwise noted, a direction (the Z axial direction) parallel to the central axis J is simply defined as an “axial direction,” a radial direction around the central axis J is simply defined as a “radial direction,” and a circumferential direction around the central axis J, that is, a circumference (θ direction) around the central axis J is simply defined as a “circumferential direction.”

Here, in this specification, the term “extending in the axial direction” includes not only extending strictly in the axial direction (the Z axial direction) but also extending in a direction inclined in a range of less than 45° with respect to the axial direction. In addition, in this specification, the term “extending in the radial direction” includes not only extending strictly in the radial direction, that is, extending in a direction perpendicular to the axial direction (the Z axial direction), but also extending in a direction inclined in a range of less than 45° with respect to the radial direction.

### Overall Structure

FIG. 1 is a cross-sectional view of an electric oil pump according to a first embodiment. As shown in FIG. 1, an electric oil pump 1 of the present embodiment includes a motor unit 10 and a pump unit 40. The motor unit 10 and the pump unit 40 are aligned in the axial direction. The motor unit 10 has a shaft 11 that is disposed along the central axis J that extends in the axial direction. The pump unit 40 is positioned on one side (front side) of the motor unit 10 in the axial direction and is driven by the motor unit 10 via the shaft 11 and discharges oil. Constituent members will be described below in detail.

### Motor Unit 10

As shown in FIG. 1, the motor unit 10 includes a resin housing 13, a rotor 20, the shaft 11, a stator 22, and a rolling bearing 25.

The motor unit 10 is, for example, an inner rotor type motor. The rotor 20 is fixed to an outer circumferential surface of the shaft 11. The stator 22 is positioned outside the rotor 20 in the radial direction. In addition, the rolling bearing 25 is disposed at a rear side (+Z side) end of the shaft 11 and rotatably supports the shaft 11.

### Resin Housing 13

As shown in FIG. 1, the resin housing 13 includes a stator holding part 13a, a circuit board holding part 13b, and a pump body holding part 13c. The stator holding part 13a, the circuit board holding part 13b, and the pump body holding part 13c are integrally molded using a resin.

### Stator holding part 13a

The stator holding part 13a extends in the axial direction and has a through-hole 13a1 therein. The shaft 11 of the motor unit 10, the rotor 20, and the stator 22 are disposed in the through-hole 13a1. An outer surface of the stator 22, that is, an outer surface of a core back part 22a to be described below, is fitted to an inner surface of the stator holding part 13a. Thereby, the stator 22 is housed in the stator holding part 13a.

The left side of an outer wall 13a2 of the stator holding part 13a of the present embodiment in the X axial direction has a left side wall 13a3 whose thickness in the radial direction of the resin increases from the front side (−Z side) to the rear side (+Z side). In addition, the right side of the outer wall 13a2 in the X axial direction has an insertion hole 13a4 which extends in the X axial direction and into which an external connector 90 is inserted. A bracket part 13a5 that supports the insertion hole 13a4 is provided on the front side of the insertion hole 13a4. The rigidity of the insertion hole 13a4 is strengthened by the bracket part 13a5.

### Circuit Board Holding Part 13b

The circuit board holding part 13b is connected to the rear side end of the stator holding part 13a. The circuit board holding part 13b has a bottomed container shape of which the rear side opens and which extends in the X axial direction and includes a container body part 13b1 and a container body side flange part 13b2.

The container body part 13b1 has a substrate housing chamber 13b3. The rear side of the substrate housing chamber 13b3 opens, and a rear side opening of the substrate housing chamber 13b3 is covered by a cover part (not shown). A circuit board 16, a motor side terminal 17, a connector side terminal 18, and the like are housed in the substrate housing chamber 13b3.

The motor side terminal 17 is disposed on the left side in the X axial direction in the substrate housing chamber 13b3, one end side is electrically connected to a coil 22b of the motor unit 10, and the other end side is electrically connected to the circuit board 16. The connector side terminal 18 is disposed on the right side in the X axial direction in the substrate housing chamber 13b3, one end side is electrically connected to the external connector 90, and the other end side is electrically connected to the circuit board 16.

The circuit board 16 outputs a motor output signal. In the present embodiment, the circuit board 16 is disposed on the rear side of the substrate housing chamber 13b3 and extends in the X axial direction. A print wiring (not shown) is provided on the back surface (front side surface) of the circuit board 16. In addition, when a copper inlay substrate is used as the circuit board 16, heat generated in a heating element (not shown) can be dissipated through the cover part.

### Pump Body Holding Part 13c

The pump body holding part 13c has a tubular shape of which the front side opens, and is continuously connected to the front side end of the stator holding part 13a. The pump body holding part 13c has a hole 13c1 that extends in the axial direction. The inner diameter of the hole 13c1 has a size that is slightly larger than the outer diameter on the rear side of a pump body 52 of the pump unit 40 to be described below. The rear side of the pump body 52 is fitted to the inner surface of the hole 13c1.

An outer surface 13c2 of the pump body holding part 13c includes a motor side flange part 13c3 that protrudes in the radial direction. The motor side flange part 13c3 is disposed to face a pump side flange part 52a provided in the pump body 52 to be described below, and is fixed to the pump side flange part 52a by a fastening unit such as a bolt. Thereby, the pump unit 40 is connected and fixed to the resin housing 13.

### Rotor 20

The rotor 20 includes a rotor core 20a and a rotor magnet 20b. The rotor core 20a surrounds the shaft 11 around the axis (θ direction) and is fixed to the shaft 11. The rotor magnet 20b is fixed to the outer surface along the axis (θ direction) of the rotor core 20a. The rotor core 20a and the rotor magnet 20b rotate together with the shaft 11. Here, the rotor 20 may be an embedded magnet type in which a permanent magnet is embedded in the rotor 20. Compared to a surface magnet type in which a permanent magnet is provided on a surface of the rotor 20, the rotor 20 of the embedded magnet type can reduce a likelihood of the magnet peeling off due to a centrifugal force, and can utilize a reluctance torque positively.

### Stator 22

The stator 22 surrounds the rotor 20 around the axis (θ direction), and rotates the rotor 20 around the central axis J. The stator 22 includes the core back part 22a, a tooth part 22c, the coil 22b, and an insulator (bobbin) 22d.

The shape of the core back part 22a is a cylindrical shape concentric with the shaft 11. The tooth part 22c extends from the inner surface of the core back part 22a toward the shaft 11. A plurality of tooth parts 22c are provided and are disposed at uniform intervals in the circumferential direction on the inner surface of the core back part 22a. The coil 22b is provided around the insulator (bobbin) 22d and is formed by winding a conductive wire 22e. An insulator (bobbin) 19 is installed to each of the tooth parts 22c. The stator 22 includes a resin molded part 22f in which the core back part 22a, the tooth part 22c, the coil 22b, and the insulator (bobbin) 22d are covered with a resin when integral molding using a resin is performed.

### Rolling Bearing 25

The rolling bearing 25 is disposed on the rear side (+Z side) of the rotor 20 and the stator 22 and is held by a rolling bearing holding part 30. The rolling bearing 25 supports the shaft 11. The shape, the structure, and the like of the rolling bearing 25 are not particularly limited, and any known bearing can be used.

The rolling bearing holding part 30 holds the rolling bearing 25.

### Shaft 11

As shown in FIG. 1, the shaft 11 extends along the central axis J and penetrates through the motor unit 10. The front side (−Z side) of the shaft 11 protrudes from the motor unit 10 and extends into the pump unit 40. The front side (−Z side) of the shaft 11 is supported by a sliding bearing 45 in the pump body 52 to be described below.

### Pump Unit 40

The pump unit 40 is positioned on one side of the motor unit 10 in the axial direction, and specifically, on the front side (−Z side). The pump unit 40 is driven by the motor unit 10 via the shaft 11. The pump unit 40 includes a pump rotor 47 and the pump housing 51. The pump housing 51 includes the pump body 52 and a pump cover 57. These components will be described below in detail.

### Pump Body 52

The pump body 52 is fixed to the front side (−Z side) of the resin housing 13 on the front side (−Z side) of the motor unit 10. The pump body 52 includes a housing part 53 in which the pump rotor 47 is housed and has a side surface and a bottom that is positioned on the rear side (+Z side) of the motor unit 10. The housing part 53 opens to the front side (−Z side) and is recessed to the rear side (+Z side). The shape of the housing part 53 when viewed in the axial direction is a circular shape.

The pump body 52 houses a sealing member 59 and has a recess 54 that is depressed from a rear side (+Z side) surface to the front side (−Z side). The shape of the recess 54 when viewed in the axial direction is a circular shape.

The pump body 52 has a through-hole 55 that penetrates along the central axis J. In the through-hole 55, both ends in the axial direction open and pass through the shaft 11, an opening on the rear side (+Z side) opens to the recess 54, and an opening on the front side (−Z side) opens to the housing part 53. The through-hole 55 functions as the sliding bearing 45 that rotatably supports the shaft 11.

In the pump body 52, a step 61 that is recessed inwardly in the radial direction on the outer surface outside in the radial direction of the rear side (+Z side) is provided. The step 61 has an end wall surface 61a having a ring shape. When a front side end 13d of the resin housing 13 is brought into contact with the end wall surface 61a, the resin housing 13 can be positioned with respect to the pump body 52 in the axial direction.

A circumferential wall surface 64 continuously extends to the rear side (+Z side) at the inner end of the end wall surface 61a in the radial direction. An annular recess 65 that is recessed to the inner side in the radial direction is provided on the rear side (+Z side) of the circumferential wall surface 64. In the recess 65, a sealing member 66, or an O-ring in the shown embodiment, is inserted.

The circumferential wall surface 64 on the front side (−Z side) with respect to the recess 65 is fitted to an inner wall surface 13e on the front side (−Z side) of the resin housing 13. Therefore, the resin housing 13 can be positioned with respect to the pump body 52 in the radial direction.

The pump side flange part 52a is provided on the outer side in the radial direction from the end wall surface 61a of the step 61. The pump side flange part 52a continuously extends in continuation with the end wall surface 61a. In the present embodiment, the four pump side flange parts 52a are provided at intervals in the circumferential direction.

The pump side flange part 52a is disposed to face the motor side flange part 13c3 when the front side end 13d of the resin housing 13 is in contact with the step 61, and when the pump side flange part 52a and the motor side flange part 13c3 are fastened by a fastening unit such as a bolt, the motor unit 10 can be fixed to the pump unit 40.

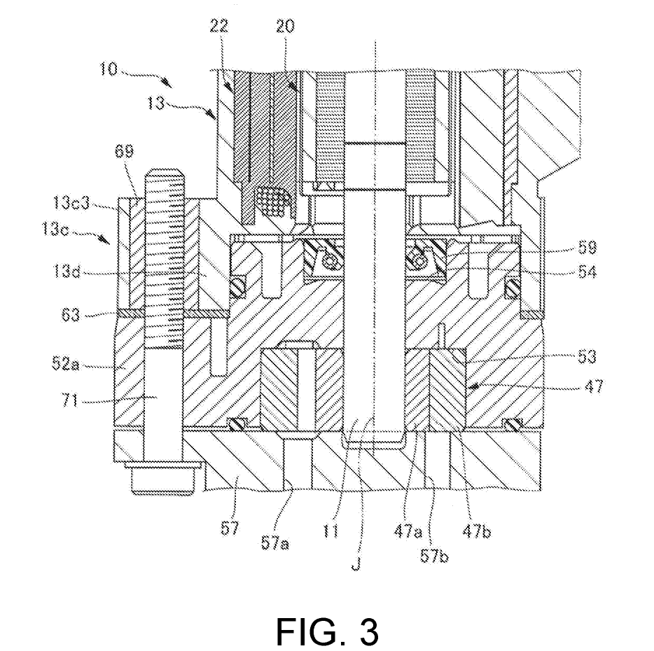

FIG. 3 is an enlarged cross-sectional view of the motor side flange part 13c3 of the resin housing 13 according to the present embodiment. In the present embodiment, as shown in FIG. 3, the front side end 13d of the resin housing 13 is in contact with the end wall surface 61a via a metal plate 63 disposed on the end wall surface 61a. The step 61 is positioned between the sealing member 59 provided in the recess 54 and the housing part 53.

In the present embodiment, the metal plate 63 is provided between the resin housing 13 and the pump body 52. In the resin housing 13, knurls are provided on the outer surface, and the collar 69 in which a female thread is provided on the inner circumferential surface is inserted thereinto, and specifically, is inserted on the step 61. The metal plate 63 has a size substantially the same as the size of the front side end 13d of the resin housing 13 in the radial direction. The reason why the metal plate 63 is disposed between the resin housing 13 and the pump body 52 is as follows. The size of the external form of the resin housing 13 cannot be increased because of a relationship with an installation space of the electric oil pump 1. Therefore, the wall thickness of the collar 69 of the resin housing 13 that is in contact with the pump body 52 of the resin housing 13 cannot be sufficiently secured. Therefore, when the resin housing 13 and the pump body 52 are fastened, there is a possibility of the pump body 52 buckling. Therefore, when the metal plate 63 made of iron is placed between the resin housing 13 and the pump body 52, even if the wall thickness of the collar 69 is not sufficiently formed, buckling can be prevented even when the pump body 52 is made of aluminum.

### Pump Rotor 47

The pump rotor 47 is installed to the shaft 11. More specifically, the pump rotor 47 is installed to the front side (−Z side) of the shaft 11. The pump rotor 47 includes an inner rotor 47a installed to the shaft 11 and an outer rotor 47b that surrounds the outer side of the inner rotor 47a in the radial direction. The inner rotor 47a has an annular ring shape. The inner rotor 47a is a gear having teeth on the outer surface in the radial direction.

The inner rotor 47a is fixed to the shaft 11. More specifically, the front side (−Z side) end of the shaft 11 is press-fitted into the inner rotor 47a. The inner rotor 47a rotates around the axis (0 direction) together with the shaft 11. The outer rotor 47b has an annular ring shape that surrounds the outer side of the inner rotor 47a in the radial direction. The outer rotor 47b is a gear having teeth on the inner surface in the radial direction.

The inner rotor 47a is engaged with the outer rotor 47b and when the inner rotor 47a rotates, the outer rotor 47b rotates. That is, the pump rotor 47 rotates according to rotation of the shaft 11. In other words, the motor unit 10 and the pump unit 40 have the same rotation axis. Thereby, it is possible to prevent the size of the electric oil pump 1 from becoming larger in the axial direction.

In addition, when the inner rotor 47a and the outer rotor 47b rotate, a volume between engaging parts of the inner rotor 47a and the outer rotor 47b changes. An area in which the volume decreases is a pressing area, and an area in which the volume increases is a negative pressure area. An intake port is disposed on the front side (−Z side) of the negative pressure area of the pump rotor 47. In addition, a discharge port is disposed on the front side (−Z side) of a pressing area Ap of the pump rotor 47. Here, oil sucked into the housing part 53 from an intake opening 57a provided in the pump cover 57 is stored in a volume part between the inner rotor 47a and the outer rotor 47b and is sent to the pressing area. Then, the oil passes through the discharge port and is discharged from a discharge opening 57b provided in the pump cover 57.

### Pump Cover 57

As shown in FIG. 1, the pump cover 57 is covered from the front side (−Z side) with respect to the pump body 52, and thus the housing part 53 is provided between the pump cover 57 and the pump body 52. In the present embodiment, the pump cover 57 is installed to the front side (−Z side) of the pump body 52 and blocks an opening 53a that opens to the front side (−Z side) of the housing part 53, and thus the housing part 53 is provided between the pump cover 57 and the pump body 52.

### Operations and Effects of Electric Oil Pump 1

Next, operations and effects of the electric oil pump 1 will be described. As shown in FIG. 1, when the motor unit 10 of the electric oil pump 1 is driven, the shaft 11 of the motor unit 10 rotates, and as the inner rotor 47a of the pump rotor 47 rotates, the outer rotor 47b also rotates. When the pump rotor 47 rotates, oil sucked from the intake opening 57a of the pump unit 40 moves through the housing part 53 of the pump unit 40, passes through the discharge port, and is discharged from the discharge opening 57b.

(1) Here, in the electric oil pump 1 according to the present embodiment, since the step 61 is provided on the outer surface outside the pump housing 51 in the radial direction, the step 61 is positioned on the other side with respect to the housing part 53 in the axial direction, and one side end of the resin housing 13 in the axial direction is fixed to the step 61, there is no step in the pump housing 51 in the periphery of the housing part 53 on the outer side in the radial direction and the other side in the axial direction. Therefore, if there is a need to increase the size of the pump rotor 47 in order to increase an amount of discharge by the pump unit 40 without increasing the size of the electric oil pump 1, in order to increase the diameter of the pump rotor 47 and increase the thickness of the pump rotor 47, it is possible to increase the degree of freedom in designing when the size of the housing part 53 is enlarged.

(2) In addition, since the pump housing 51 includes the pump body 52 and the pump cover 57, the step 61 is provided in the pump body 52, the step 61 is positioned on the other side with respect to the housing part 53 in the axial direction, and one side end of the resin housing 13 in the axial direction is fixed to the step 61, there is no step 61 in the pump body 52 in the periphery of the housing part 53 on the outer side in the radial direction and the other side in the axial direction. Therefore, if there is a need to increase the size of the pump rotor 47 in order to increase an amount of discharge by the pump unit 40 without increasing the size of the electric oil pump 1, in order to increase the diameter of the pump rotor 47 and increase the thickness of the pump rotor 47, it is possible to increase the degree of freedom in designing when the size of the housing part 53 is enlarged.

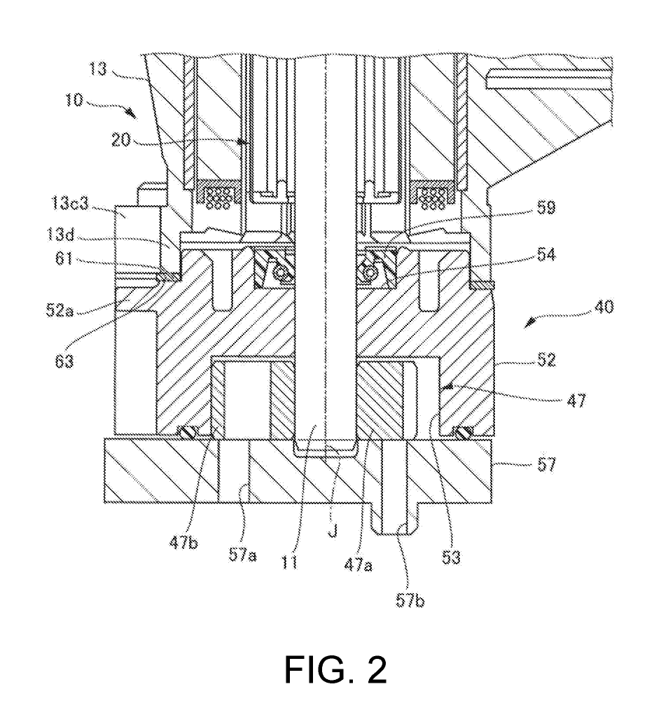

(3) In addition, as shown in FIG. 2, since the sealing member 59 is provided in the recess 54 provided on the other side surface of the pump body 52 in the axial direction and the front side end 13d of the resin housing 13 is disposed at a position at which it overlaps the sealing member 59 in the radial direction, there is no step 61 on the outer surface of the pump body 52 between the sealing member 59 and the housing part 53. Therefore, when the sealing member 59 is provided in the pump body 52, if there is a need to increase the size of the pump rotor 47 without increasing the size of the electric oil pump 1 in order to increase an amount of discharge by the pump unit 40, in order to increase the diameter of the pump rotor 47 and increase the thickness of the pump rotor 47, it is possible to increase the degree of freedom in designing when the size of the housing part 53 is enlarged.

In addition, when the sealing member 59 is provided in the recess 54 provided on the other side surface of the pump body 52 in the axial direction, it is possible to prevent a movement of oil leaked from the housing part 53 toward the motor unit.

(4) In addition, when the through-hole 55 that allows communication between the recess 54 and the housing part 53 functions as the sliding bearing 45, the shaft 11 can be supported with a simple structure, and it is possible to reduce an increase in cost of the electric oil pump 1. In addition, in order to increase an output of the electric oil pump 1, it is necessary to increase an output of the motor unit 10. However, when the output of the motor unit 10 is increased, the size of the motor unit 10 increases. Therefore, as the size of the motor increases, the diameter of a rotation shaft of the motor unit 10 increases and the size of a bearing to be used also increases. However, when the sliding bearing is used in place of the bearing, it is only necessary to consider the inner diameter of the sliding bearing and the length thereof in the axial direction in designing of the sliding bearing. Therefore, the outer side of the hole in the radial direction serving as the sliding bearing that supports the rotation shaft of the motor unit 10 is a freely designable area. Therefore, when the sliding bearing is used, it is possible to increase the degree of freedom in designing.

(5) In addition, since one side end of the resin housing 13 in the axial direction is positioned between the sealing member 59 and the housing part 53, a distance between the step 61 and the housing part 53 in the axial direction is shortened, but there is no step 61 outside the housing part 53 in the radial direction. Therefore, if there is a need to increase the size of the pump rotor 47 without increasing the size of the electric oil pump 1 in order to increase an amount of discharge by the pump unit 40, in order to increase the diameter of the pump rotor 47, it is possible to increase the degree of freedom in designing when the size of the housing part 53 in the radial direction is enlarged.

### Modified Examples of First Embodiment

### Modified Example in Which Housing Part 53 is Provided in Pump Cover 57

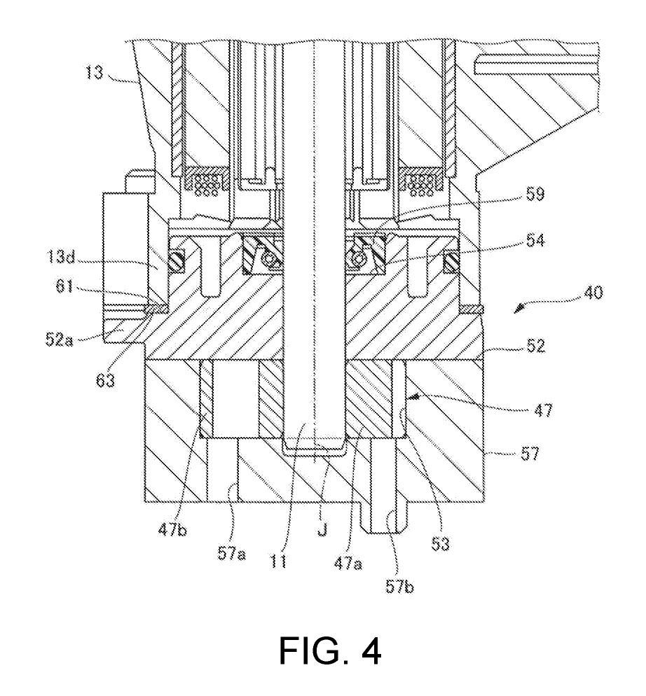

The housing part 53 according to the first embodiment shown in FIG. 1 is provided in the pump body 52 of the pump unit 40. However, the present disclosure is not limited to this structure. For example, as shown in FIG. 4, the housing part 53 may be provided in the pump cover 57 (Modified Example 1).

The pump cover 57 has the housing part 53 which is recessed from the other side surface in the axial direction to one side in the axial direction and in which the pump rotor 47 is housed. In addition, the step 61 is recessed inwardly in the radial direction of the pump body 52 on the outer surface outside the pump body 52 in the radial direction. The front side end 13d of the resin housing 13 is fixed to the step 61.

In this modified example, since the housing part 53 is provided in the pump cover 57, the step 61 is provided on the outer surface of the pump body 52, and the front side end 13d of the resin housing 13 is fixed to the step 61, there is no step in the pump cover 57 in which the housing part 53 is provided. Therefore, when the size of the pump rotor 47 is increased in order to increase an amount of discharge by the pump unit 40 without increasing the size of the electric oil pump 1, in order to increase the diameter of the pump rotor 47 and increase the thickness of the pump rotor 47, it is possible to increase the degree of freedom in designing when the size of the housing part 53 is enlarged.

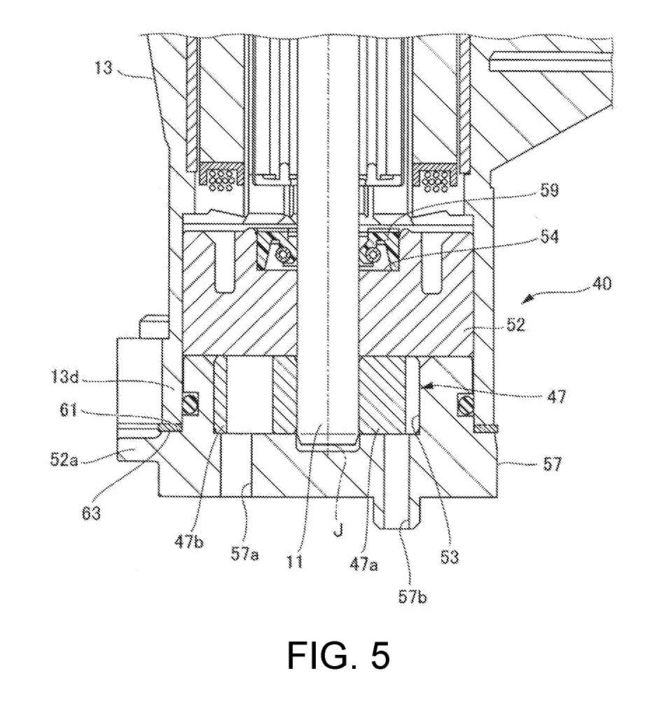

In addition, for example, as shown in FIG. 5, the housing part 53 in which the pump rotor 47 is housed is provided in the pump cover 57, the step 61 is disposed at a position at which it overlaps the housing part 53 in the radial direction, and the front side end 13d of the resin housing 13 may be fixed to the step 61 (Modified Example 2).

In this modified example, there is no step 61 on one side of the housing part 53 in the axial direction. Therefore, if there is a need to increase the size of the pump rotor 47 without increasing the size of the electric oil pump 1 in order to increase an amount of discharge by the pump unit 40, in order to increase the thickness of the pump rotor 47 in the axial direction, it is possible to increase the degree of freedom in designing when the thickness of the housing part 53 in the axial direction is increased.

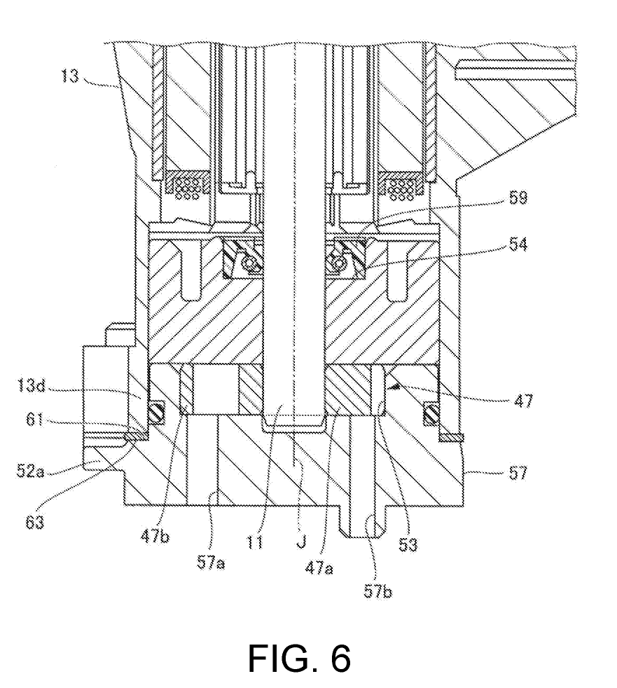

In addition, for example, as shown in FIG. 6, the housing part 53 in which the pump rotor 47 is housed is provided in the pump cover 57, the step 61 is positioned on one side in the axial direction with respect to the housing part 53, and the front side end 13d of the resin housing 13 may be fixed to the step 61 (Modified Example 3).

In this modified example, since the housing part 53 in which the pump rotor 47 is housed is provided in the pump cover 57, the step 61 is positioned on the outer surface of the pump cover 57 on one side in the axial direction with respect to the housing part 53, and the front side end 13d of the resin housing 13 is fixed to the step 61, there is no step 61 on one side of the housing part 53 in the axial direction. Therefore, if there is a need to increase the size of the pump rotor 47 without increasing the size of the electric oil pump 1 in order to increase an amount of discharge by the pump unit 40, in order to increase the thickness of the pump rotor 47 in the axial direction, it is possible to increase the degree of freedom in designing when the thickness of the housing part 53 in the axial direction is increased.

While exemplary embodiments of the present disclosure have been described above, the present disclosure is not limited to such embodiments, and various modifications and alternations within the spirit and scope of the present disclosure can be made. These embodiments and modifications thereof are included in the spirit and scope of the present disclosure and also included in the scope of claims and equivalents thereof.

What is claimed is:

1. An electric oil pump comprising:
a motor unit having a shaft centered on a central axis that extends in an axial direction of the shaft; and
a pump unit which is disposed on one side of the motor unit in the axial direction, is driven by the motor unit via the shaft, and discharges oil,
wherein the motor unit comprises
a rotor that rotates around the shaft;
a stator that is disposed to face the rotor; and
a resin housing in which the rotor and the stator are housed, wherein the pump unit comprises
a pump rotor installed to the shaft that protrudes from the motor unit to the one side in the axial direction; and
a pump housing having a housing part in which the pump rotor is housed,
wherein a step that is recessed inwardly in a radial direction of the pump housing is provided on an outer surface outside the pump housing in the radial direction,
wherein the step is disposed on an other side in the axial direction with respect to the housing part, and
wherein one side end of the resin housing in the axial direction is fixed to the step.

2. The electric oil pump according to claim 1,
wherein the pump housing comprises
a pump body including the housing part which is recessed from one side surface in the axial direction to the other side in the axial direction and in which the pump rotor is housed, and
a pump cover installed to one side of the pump body in the axial direction,
wherein the step is recessed inwardly in the radial direction of the pump body on the outer surface outside the pump body in the radial direction,
wherein the step is disposed on the other side in the axial direction with respect to the housing part, and
wherein one side end of the resin housing in the axial direction is fixed to the step.

3. The electric oil pump according to claim 2,
wherein the pump body has a recess that is depressed from an other side surface in the axial direction, and
wherein the recess comprises a sealing member through which the shaft penetrates, and
wherein one side end of the resin housing in the axial direction is disposed at a position at which it overlaps the sealing member in the radial direction.

4. The electric oil pump according to claim 3,
wherein the pump body has a through-hole that allows communication between the recess and the housing part,
wherein the through-hole is a sliding bearing that supports the shaft, and
wherein, in the pump body, the sealing member, the sliding bearing, and the pump rotor are disposed from the other side to the one side in the axial direction.

5. The electric oil pump according to claim 4,
wherein one side end of the resin housing in the axial direction is disposed between the sealing member and the housing part.

6. The electric oil pump according to claim 1,
wherein the pump housing comprises
a pump body having a recess which is recessed from the other side surface in the axial direction to the one side in the axial direction and in which a sealing member is housed; and
a pump cover installed to one side of the pump body in the axial direction,
wherein the pump cover has the housing part which is recessed from the other side surface in the axial direction to the one side in the axial direction and in which the pump rotor is housed,
wherein the step is recessed inwardly in the radial direction of the pump body on the outer surface outside the pump body in the radial direction, and
wherein one side end of the resin housing in the axial direction is fixed to the step.

7. The electric oil pump according to claim 1,
wherein the pump housing comprises
a pump body having a recess which is recessed from an other side surface in the axial direction to the one side in the axial direction and in which a sealing member is housed; and
a pump cover installed to one side of the pump body in the axial direction,
wherein the pump cover has the housing part which is recessed from the other side surface in the axial direction to the one side in the axial direction and in which the pump rotor is housed,
wherein the pump cover has the step that is recessed inwardly in the radial direction of the pump cover on the outer surface outside the pump cover in the radial direction,
wherein the step is disposed on the outer surface of the pump cover on the one side in the axial direction with respect to the housing part, and
wherein one side end of the resin housing in the axial direction is fixed to the step.

8. The electric oil pump according to claim 7,
wherein the pump body has a through-hole which extends from an other side surface of the housing part in the axial direction to the other side in the axial direction and opens to one side surface of the recess in the axial direction, and
wherein the through-hole is a sliding bearing of the shaft.
